(19) United States
(12) Patent Application Publication
(10) Pub. No.: US 2025/0130205 A1
(43) Pub. Date: Apr. 24, 2025

(54) SUSPENSION SYSTEM FOR ULTRASONIC TESTING PROBES

(71) Applicants: ROSENXT HOLDING AG, Stans (CH); ROSEN SWISS AG, Stans (CH); ROSEN 2 HOLDING AG, Stans (CH)

(72) Inventor: Achim Speck, Bruchsal (DE)

(21) Appl. No.: 18/720,640

(22) PCT Filed: Dec. 16, 2022
(86) PCT No.: PCT/EP2022/086368

§ 371 Date: Jun. 15, 2024

(30) Foreign Application Priority Data
Dec. 17, 2021 (BE) BE2021/5996

(51) Int. Cl. G01N 29/22; G01N 29/27

(52) U.S. Cl. CPC G01N 29/223; G01N 29/27; G01N 2291/262

(57) ABSTRACT

The present invention relates to a suspension arrangement for suspending ultrasonic testing probes. The present invention also relates to a support frame for a suspension arrangement of this type. The present invention also relates to a testing system with a support frame and at least one sensor, or to a testing system with a suspension arrangement. In addition, the present invention relates to a method for measuring with the suspension arrangement or with the testing system, wherein the following method steps are carried out: introducing (S100) a test piece, in a guide direction, into a holding frame with a passage for passing the test piece through in the guide direction: introducing (S200) the test piece. in the guide direction, into a support frame which is adjacent to the holding frame in the guide direction and is provided to support at least one ultrasonic testing probe for testing the test piece: and actuating (S300) the at least one sensor attached to the support frame, for an examination of the test piece using the sensor. Finally, the invention relates to a computer program which carries out this method, and to a computer-readable medium which has corresponding electronically stored method steps.

### TECHNICAL FIELD

The present invention relates to a suspension arrangement for suspending ultrasonic testing probes.

Furthermore, the present invention relates to a support frame for such a suspension arrangement.

Moreover, the present invention relates to a testing system comprising a support frame and at least one sensor or a testing system comprising a suspension arrangement.

In addition, the present invention relates to a method for measuring by use of the suspension arrangement, as well as a computer program which executes this method and a computer-readable medium on which corresponding method steps are electronically stored.

### BACKGROUND OF THE INVENTION

Ultrasonic testing systems enable non-destructive defect testing of test pieces such as pipes. Non-destructive testing is one of the most important tests for steel pipes or profiles, for example. Non-destructive testing has the advantage over destructive testing that it can be extended in the case of elongated test pieces, such as pipes, over the length of the pipe.

Existing systems for testing elongated test pieces each have a guide stage for guiding the test piece upstream and downstream a measuring stage by use of a test sensor system, which is arranged for measuring with ultrasound. The disadvantages with existing systems are their high weight as well as system inertia. Furthermore, the known systems only allow small profile deviations of the test pieces. Furthermore, the systems only guide the test sensor system correctly if the profile of the test piece is disposed in both guide stages. As a result, there are large areas at the start and end of the profile of the test piece that are not available to testing. In addition, test procedures by use of known systems take a long time. Finally, the sensor system is very difficult to access due to the guide units at both sides.

### DESCRIPTION OF THE INVENTION

Based on this situation, it is an object of the present invention to provide an improved arrangement, an improved system and an improved method. In particular, it is intended to considerably improve the quality of the measurements by use of sensors, for example ultrasonic sensors, and at the same time to facilitate maintenance work. Further, in particular, it is intended to enable testing of an elongated test piece for defects along its entire length. In particular, it is intended to enable positioning of sensors, for example of ultrasonic testing probe systems, to passing test pieces with rectangular profiles and with large positional and torsional deviations.

The object of the invention is achieved by the features of the independent main claims. Advantageous embodiments are provided in the subclaims. Where technically possible, the teachings of the subclaims can be arbitrarily combined with the teachings of the main and subclaims.

In particular, the object is thus achieved by a suspension arrangement for suspending ultrasonic testing probes. The suspension arrangement comprises: a holding frame with a feed-through opening for passing through a test piece along a guide direction; a support frame adjoining the holding frame in the guide direction for supporting at least one ultrasonic testing probe for testing the test piece; a plurality of connecting means, wherein the connecting means movably connect the holding frame and the support frame to one another; and at least one guiding means arranged on the support frame for guiding the test piece along the guide direction through a support frame opening in a mechanically contacting manner. Here, the at least one guiding means and the connecting means cooperate to move the support frame with respect to the holding frame and to align it with respect to the test piece when the test piece is inserted into the suspension arrangement while being guided by the guiding means in a mechanically contacting manner.

In the present embodiments, it is assumed that the embodiment(s) is/are fixedly installed or immovably arranged at least at the time of ultrasonic testing or other defect testing. In particular, the fixed installation or immovable arrangement is implemented directly or immediately on a fixed base.

It should be defined that the present remarks regarding above and below refer to an orientation with respect to the center of the earth, i.e. “above” refers to a point/area which is further away from the center of the earth and “below” refers to a point/area which is located closer to the center of the earth. In other words, “above” and “below” always refer to the state of the device/system in which it is fixedly installed or immobile for the purpose of defect testing.

Furthermore, “horizontal” refers to an orientation/direction that points vertically with respect to a direction of action of gravity pointing towards the center of the earth. In addition, “vertical” refers to an orientation/direction that points in the direction of action of the force of gravity pointing towards the center of the earth.

The term “suspension arrangement” means an arrangement that is designed in such a way that at least one component of the arrangement is movably attached to a specific point of at least one other component of the arrangement. In the present case, the support frame is movably attached to the holding frame. The movable attachment is ensured via the connecting means.

The test piece is in particular an elongated test piece, which can be a tube, for example. Other shapes of the test piece are conceivable. For example, the present remarks relate to a test piece which is to be inspected for defects by use of ultrasonic sensors, i.e. ultrasonic testing probes, usually by use of a coupling agent. Alternatively, it would be conceivable for the test piece to be inspected for defects by use of electromagnetic methods. Accordingly, the sensors arranged on the arrangement would then be electromagnetic sensors.

The subject matter of the application is particularly suitable for inspecting elongated test pieces for defects. “Elongated” refers to a three-dimensional geometry of a test piece body in which the body extends in two spatial directions by a multiple with respect to a third spatial direction. Such an extension of the body is present, for example, in tubes or square profiles. In particular, test pieces can be examined which, due to this dimensioning, change their shape as soon as they are not supported over their entire length while in particular affecting the measurements of an ultrasonic sensor. The change in shape can mean bending or torsion.

The holding frame is preferably configured more solid than the support frame. The holding frame is static, i.e. stationary and not movable. For this purpose, the holding frame can be fixedly and immovably connected directly or indirectly to the base. The support frame and the holding frame are in particular quadrangular in shape, wherein all sides of the quadrangle, which are each formed as webs, are arranged perpendicular to each other. The support frame is connected to the holding frame, in particular at its corner points, via the connecting means.

In particular, the connecting means extend parallel to each other. In particular, two of the connecting means, in particular two connecting means lying on a horizontal connecting line, are connected to the holding frame in the area of two corner points of an outer contour of the holding frame. Furthermore, two of the connecting means, in particular two connecting means lying on a horizontal connecting line, are connected to the holding frame in the area of two corner points of an inner contour of the holding frame formed by the feed-through opening of the holding frame. This means that two of the connecting means are connected to the holding frame at a greater distance from the feed-through opening of the holding frame and two of the connecting means are connected to the holding frame at a lesser distance from the feed-through opening. In particular, the connection points of the connecting means with the holding frame correspond to an extension of the corner points of the support frame along the guide direction of the test piece.

In particular, the connecting means are connected to the support frame and/or the holding frame in a detachable or non-detachable manner via anchors. In the case of a detachable connection of the connecting means to the anchors, for example, a testing system with support frame and sensors can be attached to the holding frame according to the properties of the test piece. For example, in the case of a test piece designed as a triangular profile, it can be advantageous if a support frame with an opening with a triangular inner contour is used. In addition to the triangular inner contour, three sensors, each with a rectilinear sensor surface, can be arranged and/or immovably attached to the support frame. In this case, each of the sensor surfaces is designed to examine one of the surfaces of the test piece and an area of the interior of the test piece. The support frame with the corresponding number of sensors and guiding means, which is adapted to the geometry of the test piece, can then be attached to the holding frame. For a test piece with a round cross-section, then a different support frame can be attached to the holding frame.

For example, the connecting means have joints at their end areas. Via the joints, in conjunction with the anchors, the degree of freedom of movement of the support frame with respect to the holding frame is determined. It is preferred that the connecting means all have the same length or are at least designed in such a way that the support frame and the holding frame can perform all movements except for a purely translational movement along the guide direction of the test piece. In other words, the holding frame and the support frame should always be at the same distance from each other, regardless of which movement the support frame performs with respect to the holding frame.

In particular, four connecting means are provided which connect the holding frame to the support frame. An alternative number of connecting means is conceivable.

The guiding means can be connected to the support frame. An embodiment of the guiding means that is immovably connected to the support frame is preferred. The guiding means can be designed in one or more parts. It is preferred that the guiding means is/are arranged around the opening of the support frame. Preferably, the guiding means is/are designed in such a way that it/they aligns/align the support frame with respect to the test piece in the direction of the opening in such a way that the test piece is always guided at the same distance from and aligned with respect to a sensor surface of the sensors, e.g. ultrasonic testing probes. According to a particularly preferred embodiment, the guiding means are made up of several parts. In this case, two guiding means are spaced apart vertically and two guiding means are spaced apart horizontally at an edge of the opening, i.e. at the inner contour, of the support frame. In other words, a total of four guiding means are arranged at a distance of 90 degrees from each other at the opening of the support frame. Preferably, a number of guiding means corresponding to a number of sensors are arranged on the support frame and/or fixed immovably to the support frame.

The opening of the support frame or the holding frame can be round or square, depending on the geometry of the test piece.

The object is further achieved by a support frame for the suspension arrangement for suspending ultrasonic testing probes. Here, the support frame is designed to support at least one ultrasonic testing probe for testing the test piece and is designed to adjoin a holding frame in the suspension arrangement in a guide direction of a test piece. The support frame comprises: a plurality of anchors, wherein the anchors are adapted to be releasably connected to the connecting means of the suspension assembly, wherein the connecting means are adapted to movably connect the holding frame and the support frame to each other; and at least one guiding means arranged on the support frame for guiding the test piece along the guide direction through a support frame opening in a mechanically contacting manner; wherein the at least one guiding means and the connecting means cooperate to move the support frame with respect to the holding frame and to align it with respect to the test piece when the test piece is inserted into the suspension arrangement by guiding the guiding means in a mechanically contacting manner.

In other words, the support frame can be exchanged depending on the requirements on the measurement with the sensors. For example, for a test piece with a rectangular cross-section, an opening corresponding to the outer contour of the test piece could be provided on the support frame. Similarly, the sensor surfaces of the ultrasonic testing probes/the ultrasonic testing probe could be correspondingly designed to be circular and/or correspondingly arranged circular at the opening. Under certain circumstances, maintenance work, e.g. on the sensors, can also be accelerated due to the interchangeability of the support frame. The support frame can always be replaced together with the connecting means or without the connecting means.

The object is further achieved by a testing system comprising a suspension arrangement or comprising a support frame. The testing system comprises at least one sensor attached to the support frame, wherein the sensor is in particular an ultrasonic testing probe. In other words, the testing system is formed by an arrangement of suspension arrangement with the at least one sensor. Alternatively, the testing system is formed by an arrangement of support frames and the at least one sensor.

In addition, the object is achieved by a method which is, in particular, at least partially computer-implemented. The method is carried out by use of the testing system and comprises at least the following method steps:
inserting (S100) a test piece along a guide direction into a holding frame comprising a feed-through opening for passing the test piece along the guide direction;
introducing (S200) the test piece along the guide direction into a support frame adjoining the holding frame in the guide direction for supporting at least one ultrasonic testing probe for testing the test piece;
wherein, when the test piece is inserted into the support frame
   guiding means, which are arranged on the support frame, wherein the guiding means are provided for guiding the test piece along the guide direction through a support frame opening in a mechanically contacting manner,
   and connecting means, wherein a plurality of connecting means are provided, wherein the connecting means movably connect the holding frame and the support frame to one another,
cooperate to move the support frame with respect to the holding frame and align it with respect to the test piece upon insertion of the test piece in steps S100 and S200 via the guiding of the guiding means in a mechanically contacting manner; and
controlling (S300) the at least one sensor attached to the support frame for examining the test piece by use of the sensor.

It is preferred that the sequence of method steps can be varied, unless technically required in an explicit sequence. However, the aforementioned sequence of method steps is particularly preferred.

Furthermore, the object is achieved by a computer program comprising instructions which cause the testing system to carry out the method steps of the method described above.

Finally, the object is achieved by a computer-readable medium on which the computer program is stored.

Advantageous aspects of the claimed invention are explained below and preferred modified embodiments of the invention are described further below. Explanations, in particular with respect to advantages and definitions of features, are basically descriptive and preferred, but not limiting, examples. If an explanation is limiting, this is explicitly mentioned. Among other things, the invention focuses on solving the problem that elongated test pieces deflect due to their own weight. In their longitudinal extension axis, i.e. main extension axis, the test pieces are therefore not formed completely straight. The problem with test devices of the prior art is that the elongated test pieces cannot be examined for defects, particularly at their end areas, by use of automated processes in which the test piece is automatically transported through the test site in a guide direction, for example. Due to the deflection, for example, the distance between the sensors, such as ultrasonic testing probes, and the test piece is caused to vary along a main extension axis of the test piece. The test piece can also be subjected to torsion. Such a torsion, too, causes the distance between the sensors, in particular ultrasonic testing probes, and the test piece to vary.

The subject matter of the application provides an arrangement which ensures a constant alignment of the support frame and the sensors, in particular ultrasonic testing probes, which are aligned with the support frame. Here, the sensors, for example ultrasonic testing probes, are particularly preferably immovably and fixedly connected to the support frame. The connecting means and the guiding means, wherein the latter are arranged on the support frame, cooperate and cause a constant alignment of the sensors, for example ultrasonic testing probes, and also of the support frame opening with respect to a surface of the test piece. On the one hand, this is ensured by the fact that the guiding means are guided on the surface of the test piece.

This is preferably achieved by the guiding means sliding on the test piece in contact with the test piece surface. On the other hand, the connecting means, which connect the holding frame to the support frame, allow the support frame to be aligned with respect to the holding frame and thus with respect to the test piece with their degrees of freedom of movement. In particular, the connecting means are designed in such a way that the ultrasonic testing probes always remain equally aligned and at the same distance from a surface of the test piece. This ensures the quality of the measurement to remain reproducible. In other words, an adaptation to any geometric variations of the test piece at an early stage when moving the test piece into the system/arrangement is enabled. In particular, this ensures that the sensors, in particular the ultrasonic testing probes, always maintain their relative position to the surfaces of the test piece. The subject matter of the application is therefore particularly suitable for reproducible ultrasonic testing of inaccurately guided test pieces with rectangular profiles and with curved longitudinal axes.

In other words, the subject matter of the application, in particular the suspension, enables a simple and rapid adaptation of the sensors to the surfaces of the test pieces to be tested. The system/arrangement is particularly suitable for test pieces with rectangular profiles. The system/arrangement also allows very inaccurate running and twisted test pieces to be tested along their entire length, i.e. including their end areas. In addition, the subject matter of the application enables a short design of the suspension arrangement/testing system and very good accessibility to the sensor system.

In summary, the subject matter of the application advantageously enables a significantly improved tracking of the test piece with a shorter, strongly reduced distance of activity and a more compact design.

According to a modified embodiment, it is provided that the connecting means movably connect the holding frame and the support frame to each other with a mobility transverse to the guide direction. In other words, in this embodiment, the holding frame and the support frame can move relative to one another in such a way that the main planes of extension of the support frame and the holding frame can enclose an angle relative to one another. Such a configuration has the advantage that test pieces with bends along their main extension axis can also be examined for defects. For example, these bends refer to bends in the test piece that are caused by a manufacturing process and not bends that are caused by the test piece's own weight. In other words, these are bent test pieces, for example brackets.

According to a modified embodiment, it is provided that the connecting means are designed to connect the support frame to the holding frame with a constant support frame alignment that is independent of a support frame movement with respect to the holding frame. Such a design of the connecting means restricts the degrees of freedom of movement of the support frame. In particular, this also further defines the variants for alignments of the sensors with respect to the test piece surface. It is also advantageously preferred that the sensors are always reproducibly aligned in the same way with respect to a test piece surface to be tested, even with larger variations in the profile geometry. In other words, when the range of application of the support frame is extended to different test piece cross-sections, the reproducibility of the measurements is simultaneously improved.

According to a modified embodiment, it is preferably provided that the connecting means are designed to connect the support frame in a support frame main extension plane with a constant support frame alignment independent of a support frame movement with respect to a holding frame main extension plane. With respect to the aforementioned exemplary embodiment in which the connecting means are designed to connect the support frame to the holding frame with a constant support frame orientation independent of a support frame movement with respect to the holding frame, it is provided in the present exemplary embodiment that the connecting means determine the movement of the support frame relative to the holding frame with respect to the main extension planes of the support frame and the holding frame. This is a particularly preferred embodiment in which, when the range of application of the support frame is extended to different test piece cross-sections, the reproducibility of the measurements is improved simultaneously.

According to a modified embodiment, it is provided that the connecting means, in particular articulated rods, are formed and arranged on the holding frame and the support frame in order to move parallel to each other. In other words, this is a spatial mechanical linkage.

This embodiment is primarily intended for testing test pieces in which the alignment of the sensors with respect to the test piece surface should always remain the same regardless of deflection/torsion. This excludes test pieces which, due to the manufacturing process, have a strong bend in their main extension axis, in particular of more than 10 degrees, e.g. 90 degrees or more, e.g. in the form of an L-profile or U-profile.

According to a modified embodiment, it is provided that two, in particular four, connecting means are provided, wherein each of the connecting means is designed as a articulated rod, wherein all connecting means, in particular all articulated rods, are of equal length. This modified embodiment is a preferred embodiment in that the connecting means, in particular articulated rods, are formed and arranged on the holding frame and the support frame in order to move parallel aligned with one another.

The articulated rods can comprise ball joints and/or hinge joints at their ends. A spatial mechanical linkage with four parallel spherical articulated rods, i.e. mounted via ball joints, which are the coupling rods of the mechanical linkage, is particularly preferred.

The above-described embodiments of the connecting means advantageously enable a more compact design and that the support frame aligns itself smoothly while adapting to the test piece geometry. For example, the suspension arrangement/testing system can be adapted to a degree of deflection of the test piece via the length of the articulated rods.

According to a modified embodiment, it is provided that a plurality of guiding means is provided, wherein the guiding means comprise: at least two lateral guide rollers arranged at a circumference of the support frame opening and/or at least two rollers arranged at a circumference of the support frame opening, of which at least one roller is a carrier roller; and/or at least two ramps arranged at the circumference of the support frame opening. It may also be provided that on a vertical connecting line, which extends perpendicular to the guide direction, or on a horizontal connecting line, which extends perpendicular to the guide direction, one roller is respectively disposed opposite one ramp. The connecting lines then always connect two guiding means with each other either in the horizontal direction or in the vertical direction.

It can also be provided that on a vertical connecting line, which extends perpendicular to the guide direction, or on a horizontal connecting line, which extends perpendicular to the guide direction, two rollers are respectively disposed opposite one ramp. The connecting lines then always connect three guiding means with each other either in the horizontal direction or in the vertical direction. It can also be provided that on a vertical connecting line, which extends perpendicular to the guide direction, or on a horizontal connecting line, which extends perpendicular to the guide direction, two rollers are respectively disposed opposite one ramp and one roller. The connecting lines then always connect four guiding means with each other either in the horizontal direction or in the vertical direction.

The above-described embodiments of the guiding means are particularly suitable for centering the support frame and guiding test pieces with a rectangular profile through the support frame. It is understood that in the case of circular test pieces or alternative test piece geometries, the guiding means can be provided in an alternative arrangement or design to that described above.

It can also be provided that on a vertical connecting line, which extends perpendicular to the guide direction, in which two rollers are respectively disposed opposite one ramp and one roller, the ramp and the roller are arranged at the bottom of the support frame and the two rollers are arranged at the top of the support frame. In other words, in the direction of gravity, and when the suspension arrangement is installed, the ramp and the roller are arranged at the bottom of the support frame and the two rollers are arranged at the top of the support frame.

In particular, according to a modified embodiment, the ramp is designed in such a way that it is the first of all guiding means to come into contact with the test piece and guide the test piece when the test piece is moved in the guide direction. Subsequently other guiding means, for example the rollers described in the previous embodiment, come into contact with the test piece. In this way, the durability of the other guiding means, e.g. rollers, is advantageously improved. This modified embodiment can relate to one or more ramps which are designed in such a way that they are the first to come into contact with the test piece. In other words, it may also be provided that the ramps are designed in such a way that they are the first of all guiding means to come into contact with the test piece and guide the test piece when the test piece is moved in the guide direction.

According to a modified embodiment it is provided that the guiding means are designed to initially align the test piece, which is moved in the guide direction from the holding frame to the support frame, horizontally with respect to the opening of the support frame and to align it vertically with respect to the opening of the support frame when the test piece is moved further in the guide direction. Alternatively, according to a modified embodiment, it is provided that the guiding means are designed to first align the test piece, which is moved in the guide direction from the holding frame to the support frame, vertically with respect to the opening of the support frame and to align it horizontally with respect to the opening of the support frame when the test piece is moved further in the guide direction.

According to a modified embodiment, it is particularly preferred that a guiding means and a sensor are arranged on each of two opposite surfaces of the support frame along the guide direction. In other words, viewed from a circumferential area of the opening of the support frame, a guiding means and a sensor are each arranged in the same area of the support frame. A test piece, which is then inserted into the arrangement/system, first slides past a guiding means/several guiding means and then past the sensor/sensors. For example, with a total of four guiding means and four sensors, the following arrangement can be provided on the support frame: at twelve o'clock, one guiding means and one sensor are respectively arranged on the support frame; at three o'clock, one guiding means and one sensor are respectively arranged on the support frame; at six o'clock, one guiding means and one sensor are respectively arranged on the support frame; and at nine o'clock, one guiding means and one sensor are respectively arranged on the support frame. This corresponds to an arrangement of a respective guiding means and a respective sensor corresponding to a 90-degree distance between each sensor or each guiding means.

The modified embodiment described above is particularly suitable, for example, for testing a test piece with a rectangular cross-section.

According to a modified embodiment it is provided that the guiding means have a compliant mounting. In this way, the alignment of the support frame to match the geometry of the test piece can advantageously be improved. In particular, the compliant mounting and the guiding means and the connecting means cooperate in the alignment of the support frame.

According to a modified embodiment, it is particularly preferably provided that one or more sensors are attached to the support frame at a distance from the support frame. For example, a spacer for setting a distance A between the support frame and the sensor can be arranged between the sensor and the support frame. For example, two sensors can be arranged on the support frame at a distance from the support frame and connected to the support frame, and two sensors can be arranged on the support frame at no distance or at a distance less than the distance A and connected to the support frame. In particular, the sensors spaced from the support frame with a spacer are attached to the support frame across a corner at an inner contour of the support frame formed by the support frame opening. In particular, the sensors connected to the support frame without a spacer are attached to the support frame across the corner at an inner contour of the support frame formed by the support frame opening.

The spacers at the sensors can be provided, for example, to align the sensors with respect to a test piece and to adjust a measuring range of the sensors in such a way that the test piece is examined for defects as completely as possible.

It may be provided that one or more sensors are attached to or arranged on the support frame via movement means, wherein the movement means are designed to adjust a distance between the sensors and the support frame. For example, depending on the geometry of the test piece, it may be necessary for the sensors to be arranged offset to one another in the guide direction. According to a modified embodiment, four sensors are provided, which are fixedly and immovably connected to the support frame. In particular, two of the four sensors can be moved by mechanical movement means, e.g. in the form of actuating means, in such a way that the distances to a surface of the test piece can be adjusted.

According to a modified embodiment, it is particularly preferably provided that the guiding means comprises a ramp or is formed from the ramp at two surfaces opposite each other along the guide direction on the support frame and that the sensor is connected to the support frame via a spacer. Furthermore, it is in particular provided that the guiding means comprises a roller or is formed from a roller and a ramp or is formed from a roller at two surfaces opposite each other along the guide direction on the support frame and the sensor is connected to the support frame without a distance to the support frame. In this modified embodiment, it is advantageous that the sensors are damaged as little as possible or not at all due to a contact with the test piece.

According to a modified embodiment, it is provided that the suspension arrangement comprises a compliant mounting arranged on the support frame, wherein the compliant mounting is designed to elastically absorb the forces of the support frame acting perpendicular to the guide direction, which act on the support frame when the test piece is inserted into the suspension arrangement and guiding means and connecting means cooperate in order to move the support frame with respect to the holding frame when the test piece is inserted via the guidance of the guiding means in a mechanically contacting manner.

The compliant mounting of the support frame and the compliant mounting of the guiding means can be provided in combination.

The compliant mounting of the support frame makes it easier to center the support frame with respect to the test piece. In addition, the components of the testing system/arrangement, for example the connecting means, are mechanically relieved.

The compliant mounting can act and be arranged in several areas on the circumference of the support frame, for example as a suspension for the support frame attached at the top of the support frame, in order to compensate for the own weight of the support frame.

It is also conceivable that the support frame is attached directly or indirectly to a base via a compliant mounting. Elements of the compliant mounting can be arranged on the support frame on a vertical connecting line between the guiding means and the elements of the compliant mounting. In addition or alternatively, the elements of the compliant mounting can also be arranged on the support frame in a horizontally offset manner, in particular horizontally offset outwards, and thus further away from the support frame opening than the guiding means. The compliant mounting advantageously facilitates a centering of the support frame with respect to the test piece.

In particular, one or more elements of the compliant mounting is/are designed as a spring system arranged on the support frame.

According to a modified embodiment, it is provided that the guiding means and the connecting means are arranged in an intermediate space formed between the holding frame and the support frame and extend along the guide direction away from the support frame in the direction of the holding frame. In this intermediate space a freedom of movement of the connecting means/support frame can be set.

According to a modified embodiment, it is provided that the sensors are attached to the support frame at a surface of the support frame facing away from the connecting means.

This advantageously enables an easier access to the sensors and simplifies the maintenance of connecting means or the sensors. Furthermore, this can also increase the freedom of movement of the connecting means/support frame, since the connection points of the connecting means at the support frame are not occupied by the sensors.

According to a modified embodiment, it is provided that, in the case of a guiding means designed as a lateral guide roller or roller, the sensors are arranged on the support frame along the guide direction at a shorter distance or without distance from the support frame and, in the case of a guiding means designed as a ramp, are arranged on the support frame along the guide direction at a greater distance from the support frame. This has the particular advantage that the sensors are not damaged when the test piece is inserted into the opening of the support frame.

According to a modified embodiment, a clamping unit is provided for holding one end of the test piece. In particular, this clamping unit is designed to be activated shortly before the end of a test piece at the support frame is reached. The clamping unit advantageously enables that the positioning of the support frame at the end of the test piece is maintained, thus facilitating a testing there as well.

### BRIEF DESCRIPTION OF THE DRAWINGS

In the following, the invention is explained in more detail with reference to the attached drawings based on preferred exemplary embodiments. The term figure is abbreviated as Fig. in the drawings.

In the drawings:

FIG. 1 shows a schematic view of the arrangement and the system according to a preferred exemplary embodiment of the invention;

FIG. 2 shows an alternative schematic view of the arrangement and the system according to the preferred exemplary embodiment of the invention;

FIG. 3 shows a schematic side view of the arrangement and the system according to the preferred exemplary embodiment of the invention;

FIG. 4 shows an alternative schematic view of the arrangement and the system according to the preferred exemplary embodiment of the invention; and

FIG. 5 shows a flowchart for a schematic representation of a method according to a possible embodiment.

### DETAILED DESCRIPTION OF THE EXEMPLARY EMBODIMENTS

The described exemplary embodiments are merely examples, which can be modified and/or supplemented in a variety of ways within the scope of the claims. Each feature described for a particular exemplary embodiment can be used independently or in combination with other features in any other exemplary embodiment. Each feature described for an exemplary embodiment of a particular claim category can also be used in a corresponding manner in an exemplary embodiment of another claim category.

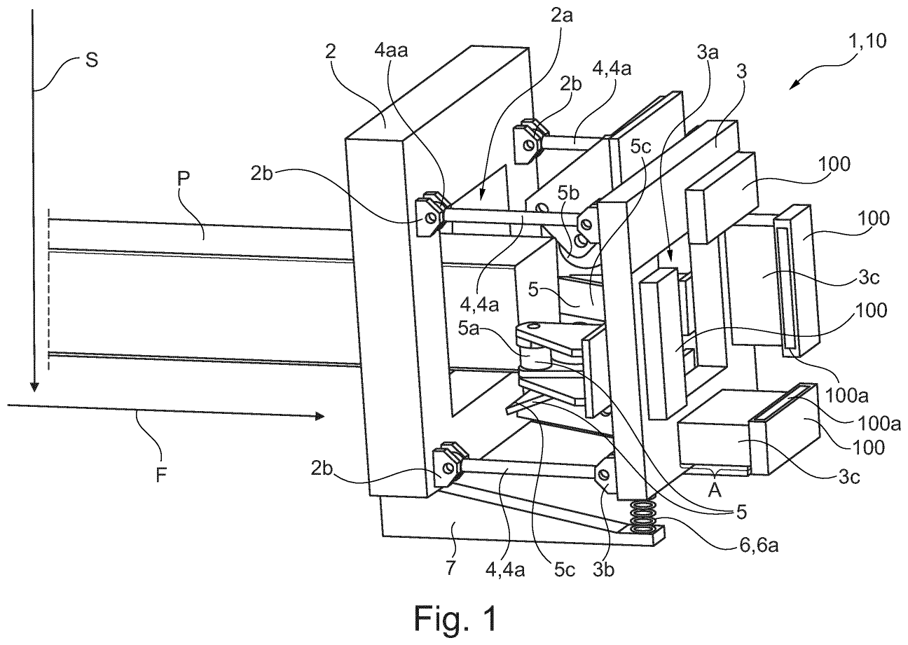

FIG. 1 shows a schematic view of a suspension arrangement 1 comprising four ultrasonic testing probes 4, all of which are part of a testing system 10. The suspension arrangement 1 comprises a holding frame 2. The holding frame 2 is arranged statically, which in the present exemplary embodiment means that it is fixedly connected to a base either indirectly or directly. The holding frame 2 comprises a feed-through opening 2a. The feed-through opening 2a is enclosed by four webs of the holding frame 2. The feedthrough opening 2a is designed to allow an elongated test piece P to pass through the feed-through opening 2a along a guide direction F. The guide direction F points in particular perpendicular to a direction of gravity S. The holding frame 2 is made of metal, plastic or an alternative suitable material.

In the present exemplary embodiment, the holding frame 2 comprises four anchors 2b. Each of the anchors 2b is arranged in a connecting area between two webs of the holding frame. At their connection points with the holding frame 2, the anchors 2b form a right-angled quadrilateral that surrounds the feed-through opening 2a. In this right-angled quadrilateral, two anchors respectively lie on a common horizontal connecting line at their connecting points. The anchors 2b, which are further away from the center of the earth, are arranged closer to the feed-through opening 2a than the anchors 2b, which are less far away from the center of the earth. In other words, the two upper anchors 2b are arranged closer to the feed-through opening 2a than the two lower anchors 2b.

Each of the anchors 2b forms a connecting piece for connecting and movably anchoring an articulated rod 4a, which in the present case forms a connecting means 4 between the holding frame 2 and a support frame 3. The support frame 3 extends with its main extension plane parallel to a main extension plane of the holding frame 2. The articulated rods 4a all have the same length. At a first end, the articulated rods 4a each have a ball joint 4aa. At an end opposite the first end, the articulated rods 4a also each have a ball joint or a hinge joint (not shown in each case). The articulated rods 4a are connected at their first end in the respective anchor 2b of the static holding frame 2. At their second end, the articulated rods 4a are respectively connected to an anchor 3b of the support frame 3.

The respective anchors 3b of the support frame 3 can be designed and arranged in the same way as the anchors 2b configured on the holding frame 2. In addition, it is understood that the anchors 2b of the holding frame 2 and the anchors 3b of the support frame 3 are each designed in such a way that they hold the respective end of the articulated rod 4a and at the same time enable a movement corresponding to the degrees of freedom of a ball joint or a hinge joint. It is preferred that the articulated rods 4a each have a ball joint 4aa at both ends. In this way, the articulated rods 4a enable a movement of the support frame 3 with respect to the holding frame 2, in which the support frame 3 is always aligned parallel in its main extension plane with respect to the main extension plane of the holding frame 2.

The support frame 3 comprises a support frame opening 3a, which is suitable for guiding the test piece P along the guide direction F through the opening 3a. The support frame 3 can have a similar design as the holding frame 2 and have a rectangular outer contour and a rectangular inner contour surrounding the opening 3a, just like the holding frame 2. In the present exemplary embodiment, the support frame 3 is configured proportionally smaller than the holding frame 2, both in its outer contour and in its inner contour. The support frame 3 is also formed less solid, in particular narrower along the guide direction F, than the holding frame 2. This has the advantage that the support frame 3 is more mobile with respect to the holding frame 2 and, in addition, the articulated rods 4a are less quickly exposed to wear at their ball joints. The support frame 3 can be made of the same or a lighter material than the holding frame 2.

The support frame 3 comprises the four ultrasonic testing probes 100, which are positioned around the opening 3a. In particular, the ultrasonic testing probes 100 are fixedly connected to the support frame 3 and carry out every movement that the support frame 3 performs with respect to the holding frame 2. The ultrasonic testing probes 100 point with their sensor surfaces 100a in the direction of the opening 3a of the support frame 3 and thus in the direction of a test piece P passing through the opening 3a.

In the present exemplary embodiment, two of the ultrasonic testing probes 100 are directly connected to the support frame 3. In other words, there is no or only a small distance between the respective ultrasonic testing probe 100 and the support frame 3. The ultrasonic testing probes 100, which are at a small distance from the support frame 3, are arranged across the corner at the opening 3a on the support frame 3. In particular, the ultrasonic testing probes 100 are arranged with their sensor surfaces 100a rectangular to each other. It is understood that, depending on the geometry of the test piece P or the requirements on the ultrasonic testing 100, both the opening 3a of the support frame 3/the holding frame 2 and/or the alignment, number and design of the ultrasonic testing probes 100 are adapted accordingly. Two further ultrasonic testing probes 100, arranged diagonally with respect to the ultrasonic testing probes 100 which are disposed in a lesser distance from the support frame 3, are arranged at a greater distance from the support frame 3 on the support frame 3. The latter two ultrasonic testing probes 100, like the former two less distanced ultrasonic testing probes 100, are also arranged across the corner at the opening 3a. The latter two distanced ultrasonic testing probes 100 are connected to the support frame 3 via a spacer 3c. A distance A between the support frame 3 and the ultrasonic testing probe 100 along the guide direction F is bridged by use of the spacer 3c. By use of the spacer 3c an angled alignment of the ultrasonic testing probe 100 with respect to the guide direction F/the test piece P, can be set depending on the requirements on the measurement by use of the ultrasonic testing probes 100. In addition, the ultrasonic testing probes 100 disposed at a distance can be aligned at an angle with respect to the guide direction F/testing piece P.

The ultrasonic testing probes 100 can be of the same or different design, depending on the requirements. The ultrasonic testing probes 100 are arranged on a side of the support frame 3 facing away from the anchors 3b, i.e. facing away from the surface, of the support frame 3.

First, the holding frame 2 is located in the guide direction F of the test piece P. Subsequently the anchors 2b of the holding frame 2 are disposed. Subsequently the articulated rods 4a are disposed. Subsequently the anchors 3b of the support frame 3 are disposed. Subsequently the support frame 3 is disposed. Subsequently to the support frame 3 in the guide direction F the ultrasonic testing probes 100 or their spacers 3c are disposed.

In an intermediate space formed along the guide direction F between the support frame 3 and the holding frame 2, the anchors 2b and 3b are located on the one hand. On the other hand, guiding means 5 are arranged in the intermediate space. The guiding means 5 are used to guide the test piece P through the opening 3a of the support frame 3. Here, the guiding means 5 interact with the articulated rods 4a and align the support frame 3 with respect to the holding frame 2. Here, the guiding means 5 are guided at and on a surface of the test piece P and therefore interact with the surface of the test piece P in such a way that the support frame 3 is moved along with the surface progression of the test piece P.

In the present example, the guiding means 5 comprise several rollers 5b, of which one roller 5b arranged at an upper area of the opening 3a of the support frame 3 is shown visibly in FIG. 1. The visible roller 5b protrudes with its running surface into the opening 3a in order to prevent the test piece P from bumping in an upper area of the opening 3a of the support frame 3. The visible roller 5b is held movably on the support frame 3. A ramp 5c is arranged vertically opposite the roller 5b as a further guiding means 5 at the opening 3a. The ramp 5c has a gradient such that it forms a connecting line between a lower web of the holding frame 2 and the inner contour of the opening 3a. The test piece is aligned vertically in relation to the opening 3a of the support frame 3 via the ramp 5c in cooperation with the roller 5b.

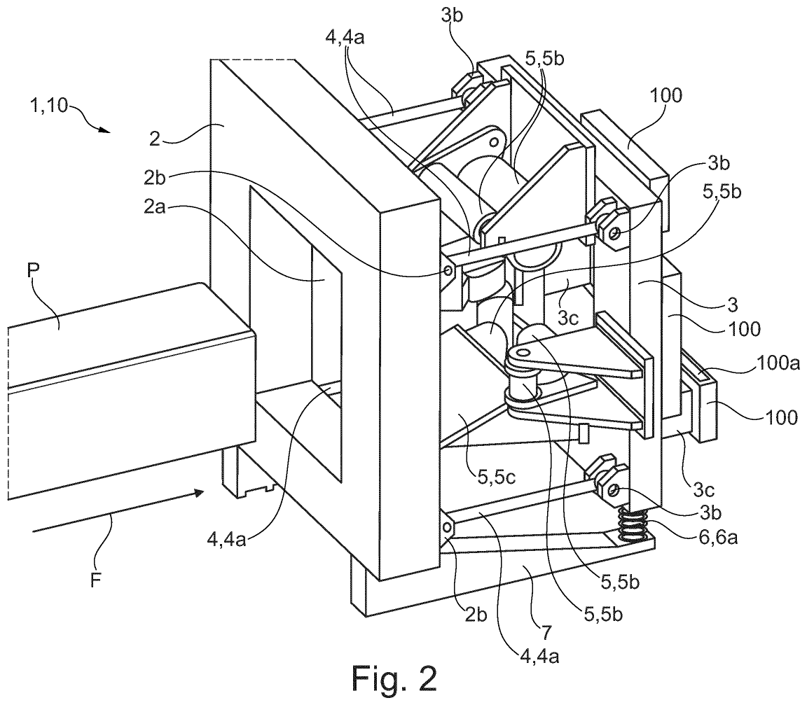

Lateral guide rollers 5a can be provided as further guiding means 5. The lateral guide rollers 5a are arranged at a circumference of the opening 3a, preferably on a horizontal connecting line on the support frame 3, and are connected to the support frame 3. In a further view according to FIG. 2, further rollers 5b and 5a can be seen.

Embodiments are conceivable in which the guiding means 5 are all not connected to the support frame 3 or are partially connected to the support frame 3, i.e. only two of the four guiding means 5, for example. Fewer guiding means 5, e.g. three, or more guiding means 5 can be provided, too. The decisive factor is that the guiding means 5 and the connecting means 4 can cooperate in order to align the support frame 3 with respect to the holding frame 2 when the test piece P is inserted through the opening 3a.

The lateral guide rollers 5a are arranged on a holder which, in the present exemplary embodiment, fixedly and immovably connects the respective lateral guide roller 5a to the support frame 3. A ramp 5c is respectively arranged between the respective lateral guide roller 5a and the support frame 3. The respective ramp 5c can have an analogous gradient, arrangement and design as the ramp 5c vertically opposite the roller 5b. The lateral ramps 5c are preferably formed shorter along the guide direction F than the lower ramp 5c vertically opposite the roller 5b. In particular, all ramps 5c are designed in such a way that their end sides closest to the support frame 3 project beyond the inner edge of the opening 3a, i.e. project into the opening 3a, which prevents that the test piece P comes into contact with the support frame 3 when it slides into the opening 3a. Alternatively or additionally, the inner contour of the support frame 3 can be formed smaller, as a result of which there is also more contact surface area between a respective holder of the guiding means 5 and the support frame 3.

In any case, the ultrasonic testing probes 100 are arranged on the support frame 3 and connected to the support frame 3 in such a way that their sensor surfaces 100a are at a distance from the test piece P passing through the opening 3a. The distance should be as small as possible. For this purpose, different suspension arrangements 1 can be provided depending on the geometry/design of the test piece P, for example. It is also conceivable that the support frame 3, together with the ultrasonic testing probes 100 attached to it, is releasably attached to the holding frame 2. This is particularly conceivable if the entire arrangement 1 or the system 10 tests lighter test pieces P and therefore the anchors 2b or 3b for the joints of the articulated rods 4a are not exposed to high mechanical loads. For example, the anchors 2b, 3b can be designed as a type of click system for the purpose of releasable fastening the joint heads of the articulated rods 4a in the anchors 2b, 3b. The articulated rods 4a can then be snapped into the anchors 3b or 2b when the support frame 3 is replaced. Alternative releasable connections are conceivable. For example, the articulated rods 4a can be formed from two parts as respective telescopic rods and can be connected to each other in a form-fitting and/or force-fitting manner to connect the holding frame 2 to the support frame 3.

The support frame 3 is mounted via a compliant mounting 6. In the present exemplary embodiment, the compliant mounting 6 consists of spiral springs 6a, which are respectively arranged at both lower edges of the support frame 3. In the present exemplary embodiment, the spiral springs 6a are each mounted via a counter-bearing at a base 7. In the present exemplary embodiment, the holding frame 2 is also fixedly and immovably connected to the base 7. Alternative versions of a counter-bearing of the compliant mounting 6 or the immovable connection of the holding frame 2 are conceivable.

In particular, a reduction in the thickness of the base 7 in the guide direction F from the retaining frame 2 to the support frame 3 corresponds to an adjustment path for generating a restoring force of the compliant mounting 6.

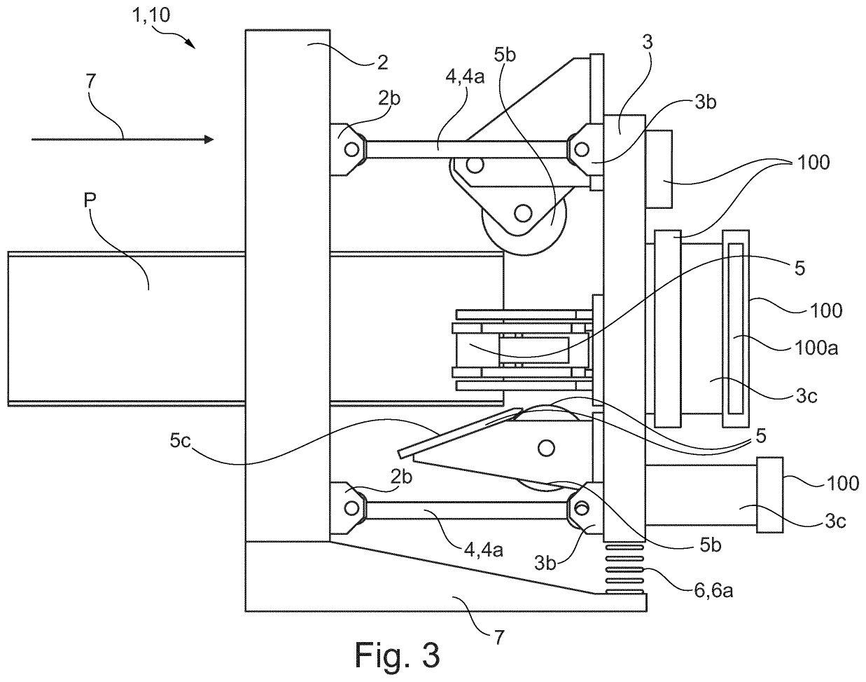

FIG. 3 shows a schematic side view of the arrangement 1/the system 10 according to the embodiment of FIG. 1. In FIG. 3, a sensor surface 100a of one of the sensors 100 is particularly clearly visible in a plan view. Furthermore, it is particularly clearly visible in FIG. 3 how the test piece P comes into contact with the guiding means 5 when it is inserted further into the arrangement 1/the system 10 in the guide direction F than in the embodiment shown in FIG. 1. Here, in the present embodiment the test piece P first comes into contact with the roller 5b and then with the ramp 5c. For example, the lateral guiding means 5 are designed in such a way that the test piece P, before it comes into contact with the roller 5b or the ramp 5c, comes into contact with the lateral guide rollers 5a and in this way is first aligned horizontally and then vertically.

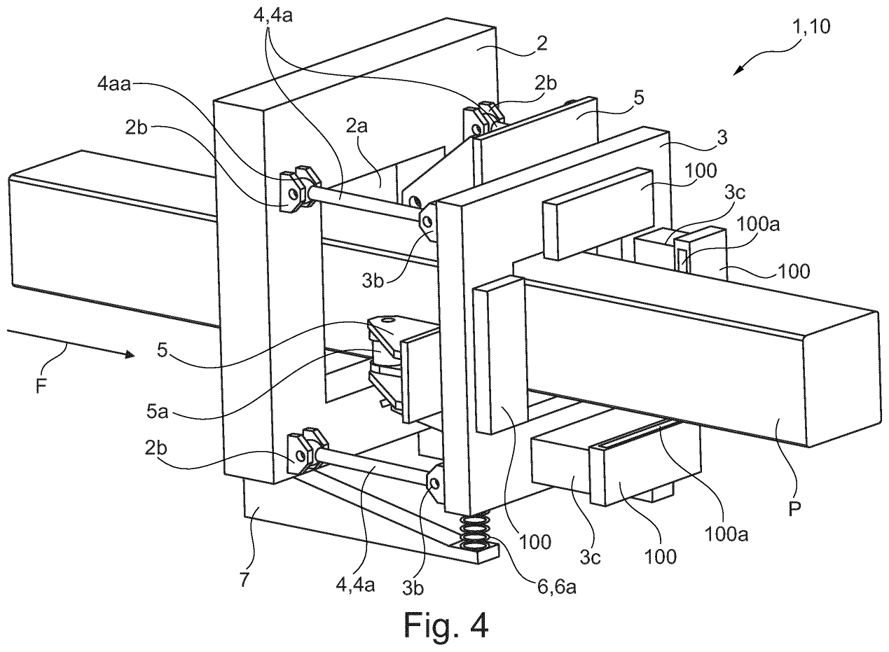

In the view of FIG. 4, the test piece P is guided even further along the guide direction F through the arrangement 1/system 10 than in the view of the device/system of FIGS. 1 to 3. The guiding means 5 align the test piece P with respect to the support frame 3 in such a way that the test piece P has the same distance with respect to all the inner edges formed by the support frame opening 3a. It goes without saying that the test piece P must be aligned in such a way that the ultrasonic testing probes 100 can detect defects within and at the test piece P reliably and reproducibly.

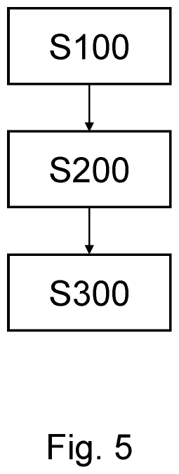

FIG. 5 shows a flow chart of a method according to a possible embodiment. The method is at least partially computer-implemented. In particular, the movement of the test piece P is implemented automated, wherein suitable known means, e.g. driven conveyor rollers and/or a conveyor belt (both not shown), move the test piece P in the guide direction F and thus in a direction of movement from the holding frame 2 to the support frame 3.

First, the test piece P is inserted into the holding frame 2 along the guide direction F. This is method step S100. The test piece P is moved further in the direction of the support frame 3. By moving the test piece P further, which can be done continuously, the test piece P is then inserted into the opening 3a of the support frame 3. This corresponds to step S200. During the insertion of the test piece P into the opening 3a, the guiding means 5 and the connecting means 4 of the support frame 3 cooperate. Here, the guiding means 5 are arranged on the support frame 3 and are used to guide the test piece P along the guide direction F through the support frame opening 3a in a mechanically contacting manner. The plurality of connecting means 4 movably connect the holding frame 2 and the support frame 3 to each other. The guiding means 5 and the connecting means 4 cooperate to move the support frame 3 with respect to the holding frame 2 and to align it with respect to the test piece P when the test piece P is inserted in steps S100 and S200 via the guidance of the guiding means 5 in a mechanically contacting manner.

When the test piece P is guided through the opening 3a of the support frame 3, the at least one sensor attached to the support frame 3 is controlled in order to examine the test piece P by use of the sensor. This corresponds to step S300.

### LIST OF REFERENCE SYMBOLS

1 suspension arrangement
2 support frame
2a feed-through opening
2b anchoring at the holding frame
3 support frame
3a support frame opening
3b anchoring at the support frame
3c spacer
4 connecting means
4a articulated rod
4aa ball joint
5 guiding means
5a lateral guide roller
5b roller
5c ramp
6 compliant mounting
6a spiral spring
7 base
10 testing system
100 ultrasonic testing probe
100a sensor surface
F guide direction
P test piece
S direction of gravity

1. A suspension arrangement (1) for suspending ultrasonic testing probes (100), comprising:
a holding frame (2) comprising a feed-through opening (2a) for passing a test piece (P) along a guide direction (F);
a support frame (3) adjoining the holding frame (2) in the guide direction (F) for supporting at least one ultrasonic testing probe (100) for testing the test piece (P);
a plurality of connecting means (4), wherein the connecting means (4) movably connect the holding frame (2) and the support frame (3) to one another; and
at least one guiding means (5) arranged on the support frame (3) for guiding the test piece (P) in a mechanical contacting manner along the guide direction (F) through a support frame opening (3a),
wherein the at least one guiding means (5) and the connecting means (4) cooperate in order to move the support frame (3) with respect to the holding frame (2) and to align it with respect to the test piece (P) via the guidance of the guiding means (F) in a mechanically contacting manner, when the test piece (P) is inserted into the suspension arrangement (1).

2. The suspension arrangement (1) according to claim 1, wherein the connecting means (4) movably connect the holding frame (2) and the support frame (3) to each other with a mobility transverse to the guide direction (F).

3. The suspension arrangement (1) according to claim 1, wherein the connecting means (4) are designed to connect the support frame (3) to the holding frame (2) with a constant support frame orientation independent of a support frame movement with respect to the holding frame (2).

4. The suspension arrangement (1) according to claim 1, wherein two, in particular four, connecting means (4) are provided, wherein each of the connecting means (4) is designed as an articulated rod (4a), wherein all articulated rods (4a) are of equal length.

5. The suspension arrangement (1) according to claim 4, wherein the articulated rods (4a) are formed and arranged on the holding frame (2) and support frame (3) such as to move in parallel alignment with each other.

6. The suspension arrangement (1) according to claim 1, wherein a plurality of guiding means (5) is provided, wherein the guiding means (5) comprise:
at least two lateral guide rollers (5a) arranged at a circumference of the support frame opening (3a) and/or at least two rollers (5b) arranged at the circumference of the support frame opening (3a), of which at least one roller (5b) is a support roller; and/or
at least two ramps (5c) arranged at a circumference of the support frame opening (3a).

7. The suspension arrangement (1) according to claim 1, comprising a compliant mounting (6) arranged on the support frame (3), wherein the compliant mounting (6) is designed to elastically absorb the forces of the support frame (3) acting perpendicular to the guide direction (F), which act on the support frame (3) when the test piece (P) is inserted into the suspension arrangement (1) and guiding means (5) and connecting means (4) cooperate in order to move the support frame (3) with respect to the holding frame (2) via the guidance of the guiding means (5) in a mechanically contacting manner, when the test piece (P) is inserted.

8. The suspension arrangement (1) according to claim 1, wherein the guiding means (5) and the connecting means (4) are arranged in an intermediate space formed between the holding frame (2) and the support frame (3) and extend along the guide direction (F) away from the support frame (3) in the direction of the holding frame (2).

9. A support frame (3) for the suspension arrangement (1) for suspending ultrasonic testing probes (100) according to claim 1, wherein the support frame (3) is designed to support at least one ultrasonic testing probe (100) for testing the test piece (P), and is designed to adjoin a holding frame (2) in the suspension arrangement (1) in a guide direction (F) of a test piece (P),
wherein the support frame (3) comprises:
a plurality of anchors (3b), wherein the anchors (3b) are configured to be releasably connected to the connecting means (4) of the suspension arrangement (1), wherein the connecting means (4) are configured to movably connect the holding frame (2) and the support frame (3) to each other; and
at least one guiding means (5) arranged on the support frame (3) for guiding the test piece (P) in a mechanically contacting manner along the guide direction (F) through a support frame opening (3a),
wherein the at least one guiding means (5) and the connecting means (4) cooperate in order to move the support frame (3) with respect to the holding frame (2) and to align it with respect to the test piece (P) via the guidance of the guiding means (F) in a mechanically contacting manner, when the test piece (P) is inserted into the suspension arrangement (1).

10. The support frame (3) according to claim 9, comprising the guiding means (5) according to claim 6 and/or the mounting (6) according to claim 7 and/or the connecting means (4) according to claim 1.

11. A testing system (10), comprising a suspension arrangement (1) according to claim 1 or comprising a support frame (3) according to claim 9, wherein the testing system (10) comprises at least one sensor attached to the support frame (3), wherein the sensor is in particular an ultrasonic testing probe (100).

12. The testing system (10) according to claim 11, wherein the sensors, in the case of a guiding means (5) designed as a lateral guide roller (5a) or roller (5b), are arranged on the support frame (3) along the guide direction (F) at a shorter distance or without distance from the support frame (3) and, in the case of a guiding means (5) designed as a ramp (5c), are arranged on the support frame (3) along the guide direction (F) at a greater distance (A) from the support frame (3).

13. A method, in particular at least partially computer-implemented, carried out by use of the testing system (10) according to claim 11, wherein the method comprises at least the following method steps:
inserting (S100) a test piece (P) along a guide direction (F) into a holding frame (2) comprising a feed-through opening (2a) for passing the test piece (P) along the guide direction (F);
inserting (S200) the test piece (P) along the guide direction (F), into a support frame (3) adjoining the holding frame (2) in the guide direction (F) for supporting at least one ultrasonic testing probe (100) for testing the test piece (P),
wherein, when the test piece (P) is inserted into the support frame (3):
guiding means (5) which are arranged on the support frame (3), wherein the guiding means (5) are provided for guiding the test piece (P) in a mechanically contacting manner along the guide direction (F) through a support frame opening (3a), and
connecting means (4), wherein a plurality of the connecting means (4) are provided, wherein the connecting means (4) movably connect the holding frame (2) and the support frame (3) to one another,
cooperate to move the support frame (3) with respect to the holding frame (2) and to align it with respect to the test piece (P), when the test piece (P) is inserted in steps S100 and S200, via the guidance of the guiding means (5) in a mechanically contacting manner; and
controlling (S300) the at least one sensor attached to the support frame (3) for examining the test piece (P) by use of the sensor.

14. A computer program, comprising instructions that cause the testing system (10) of claim 11 to perform the method steps according to claim 13.

15. A computer-readable medium, on which the computer program according to claim 14 is stored.
